(19) United States
(12) Patent Application Publication
(10) Pub. No.: US 2025/0355683 A1
(43) Pub. Date: Nov. 20, 2025

(54) ADAPTIVE NAVIGATION AND CONTENT-FIRST DYNAMIC SYSTEM

(71) Applicant: Brain Technologies, Inc., San Mateo, CA (US)

(72) Inventors: Sheng Yue, San Mateo, CA (US); Clive Gomes, San Mateo, CA (US)

(21) Appl. No.: 19/061,849

(22) Filed: Feb. 24, 2025

Related U.S. Application Data
(60) Provisional application No. 63/557,444, filed on Feb. 23, 2024.
(60) Provisional application No. 63/685,212, filed on Aug. 20, 2024.

(51) Int. Cl. G06F 9/451; G06F 3/01; G06F 11/34

(52) U.S. Cl. CPC G06F 9/451; G06F 3/016; G06F 11/3438

(57) ABSTRACT

A system displays a first set of generative interfaces in a user interface. Each generative interface includes user interface elements that contain content specifying information of the generative interface. Responsive to receiving a user interaction with a user interface element, the system activates a dynamic input phase that dynamically generates responses during runtime of receiving user inputs to the user interface. The system receives a second user input and applies a machine learning model to the generative interface comprising the interacted user interface element, the content contained in the interacted user interface element and the content from the second user input. The system receives content as an output and updates the user interface to display a second set of generative interfaces. The second set of generative interfaces may include one or more runtime-determined user interface elements, and each runtime-determined user interface element include information associated with the received content.

### CROSS-REFERENCE TO RELATED APPLICATIONS

This application claims the benefit of U.S. Provisional Application No. 63/557,444, filed Feb. 23, 2024, and the benefit of U.S. Provisional Application No. 63/685,212, filed Aug. 20, 2024, the disclosures of which are hereby incorporated by reference herein in their entireties.

### TECHNICAL FIELD

The present disclosure generally relates to software applications and, particularly, dynamic generation and adaptive navigation of content.

### BACKGROUND

In today's web, content is organized into web pages. Search engines make it easier to navigate through these pages and find relevant content. The search engine acts as a centralized forum where users can provide input describing the type of content they are looking for, and the search engine provides a set of options-typically as content cards-that link to the web pages containing the original content. Users of the search engine are provided a summary of the content in the content cards. The search results (i.e., content cards) are divided into categories based on the type of content (i.e., web pages, images, videos, etc.), and each type of content is typically placed in separate tabs. There are cases where some tabs have an intermix of content types, however, the combinations are pre-determined. Thus, users have to sift through the tabs to find the right content for their needs. Additionally, the search experience is often passive. The search results only connect the users to a ranked set of relevant web pages and the users need to sift through the content and find the content they want. Moreover, once the user is taken to the full content web page, the navigation assistance provided by the search engine ends there. Thus, if the user wants to navigate to other content related to the content they are viewing, the user needs to open up a new search engine session and craft a new search query by describing the content they are currently viewing, in additional what they want to see next. These provide a disconnected and user-intensive experience with limited control and more of the heavy lifting on the user.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

Figure (FIG. 1 is a high-level block diagram of a system environment for a data processing service in accordance with one or more embodiments.

FIG. 2 is a block diagram graphically illustrating a process for dynamic layout software program generating target content upon receiving a user input.

FIG. 3 is a block diagram illustrating an example knowledge database, in accordance with one or more embodiments.

FIG. 4 is a block diagram illustrating a dynamic content management module, in accordance with one or more embodiments.

FIG. 5 is a block diagram illustrating an example inherently decomposable user interface (IDUI), in accordance with one or more embodiments.

FIG. 6 illustrates an example process for deriving context in a dynamic layout software program, in accordance with one or more embodiments.

FIGS. 7A-7D illustrate a set of example user interface of a dynamic layout software program, in accordance with one or more embodiments.

FIGS. 8A-8B illustrate another set of example user interface of a dynamic layout software program, in accordance with one or more embodiments.

FIGS. 9A-9B illustrate another set of example user interface of a dynamic layout software program, in accordance with one or more embodiments.

FIGS. 9C-9D illustrate another set of example user interface of a dynamic layout software program, in accordance with one or more embodiments.

FIGS. 10A-10D illustrate another set of example user interface of a dynamic layout software program, in accordance with one or more embodiments.

FIG. 11 illustrates a structure of an example neural network is illustrated, in accordance with one or more embodiments.

FIG. 12 is an example machine to read and execute computer readable instructions, in accordance with one or more embodiments.

### DETAILED DESCRIPTION

The figures depict various embodiments of the present configuration for purposes of illustration only. One skilled in the art will readily recognize from the following discussion that alternative embodiments of the structures and methods illustrated herein may be employed without departing from the principles of the configuration described herein.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Embodiments are related to a dynamic content generation and navigation system. The system may generate and display a first set of generative interfaces in a user interface. Each generative interface may include user interface elements, and each user interface element may contain content specifying information of the generative interface. The system may monitor user inputs to the user interface, and the user inputs may include at least a user interaction from a user with a user interface element. Responsive to receiving the user interaction with a user interface element in a generative interface, the system activates a dynamic input phase of the user interface that dynamically generates responses during runtime of receiving user inputs to the user interface. The system updates the user interface by accentuating the user interface element that is interacted by the user. The system may receive a second user input during the dynamic input phase and identify content from the second user input using a natural language analysis. The system may apply a machine learning model to the generative interface comprising the interacted user interface element, the content contained in the interacted user interface element and the content from the second user input. The system receives content as an output from the machine learning model and updates the user interface to display a second set of generative interfaces. The second set of generative interfaces may include one or more runtime-determined user interface elements, and each runtime-determined user interface element include information associated with the received content.

In one aspect, the disclosure provides a dynamic layout software program which derives implicit context from external sources based on explicit context from a user input. The system supports a user interface of a dynamic layout software program. The user interface is displayed at a user device and includes a set of generative interfaces. Each generative interface may include one or more grids, and each grid may contain explicit context specifying information of the generative interface. The system may monitor, from a user, user inputs to the user interface. The user inputs may include at least a tactile input from the user. The system receives a tactile input from the user interacting with one of the set of generative interfaces and activates a tactile input phase of the user interface. The tactile input phase dynamically generates responses during runtime of receiving user inputs to the user interface. The system may identify at least one grid of the interacted generative interface corresponding to the tactile input. The system may update the user interface by accentuating the at least one grid with the respective explicit context. The system may receive a user voice input during the tactile input phase and identify explicit context from the voice input. The system may apply a machine learning model to the interacted generative interface, the explicit context from the at least one grid of the interacted generative interface and the explicit context from the voice input and receive an output from the machine learning model explicit context in an additional grid of the interacted generative interface. The system may update the user interface that reflects the additional grid to indicate the overall explicit context to the user. In some embodiments, the system may identify implicit context based on the explicit context and use both of the explicit context and implicit context to generate a target content in response to the user input.

The disclosed configuration provides an automatic content navigation processing system and/or process for users navigating through content. The disclosed system allows related/relevant content of different types to be placed collectively in the same feed (not in separate tabs) depending on the user needs (the combination is not predetermined), brings all related/relevant content to the user (potentially from a variety of sources) in a single interface rather than simply providing a summary and a link to the original web page, reducing the need for the users to visit the linked web page (unless that is their intention). The automatic content navigation provided herein enables an experience where users can navigate from one content (of any type) to another content (of any type) through a uniform and smooth navigation, providing a more user-centric means of exploring and consuming content. The system may apply models and artificial intelligence (AI) technologies that link all information/content together based on the user's need. Additionally, the disclosed system also adds a new interaction pattern that enables users to automatically navigate from one content to another related/relevant content with ease.

Traditional digital interfaces constrain users to predetermined navigation patterns that do not reflect how humans naturally explore information. Whether through hierarchical menus, category-based navigation, or linear conversation flows, these systems impose artificial boundaries between different types of content and force users to manually maintain context across multiple interfaces or tabs. This disclosure provides an “Anything-to-Anything” interaction pattern which reimagines this relationship between users and digital information. Rather than treating different content types as isolated entities that must be accessed through separate channels, the disclosed configuration herein creates a unified exploration space where any piece of information can naturally lead to any other relevant piece, regardless of its type or source.

In another aspect, the disclosure herein provides a hierarchical knowledge database that bridges the gap between explicit user queries and implicit intent through systematic organization and use of different types of knowledge databases. By separating the knowledge storage into distinct levels-intent, recency, domain, identity, and world knowledge—the system can process and combine different aspects of context to understand what users truly mean. The system implements these levels through specific storage and retrieval mechanisms suited to their different requirements. Information retrieval processes adapt to different types of storage, from high-speed memory stores for immediate context to external application programming interfaces (APIs) for real-time world knowledge. The integration approaches sequentially, parallelly, or in a hybrid manner, providing flexibility in how this information is combined to build understanding. Through this organization and embodiment, the system can process user inputs ranging from simple queries to complex multi-modal interactions, building rich understanding that considers both explicit statements and implicit meaning.

In another aspect, the disclosure provides a dynamic content management which includes a background layer that builds a graph of retrieved information and a focal lens that determines what information comes into focus for the user. The dynamic content management allows the system to maintain rich, meaningful relationships between different pieces of information while keeping track of how they may be relevant to the user's evolving needs. The dynamic content management maintains context while enabling fluid navigation, its understanding of information relationships, and its resource management make it applicable across many domains.

In another aspect, the disclosure provides an inherently decomposable user interface (IDUI) architecture that includes a layered approach where component identity is decentralized across concentric layers of functionality. Each layer maintains its own complete set of properties, state, behavior, and appearance making it self-sufficient and capable of functioning independently even if inner or outer layers are removed or modified. In this layered approach, a layer or section in the UI may be reused without refactoring or breaking the UI. Thus, this decentralized approach fundamentally changes the UI composition. Instead of building predetermined components with fixed boundaries, this layered approach generates fluid, adaptable interfaces through layers of functionality that branch and terminate at leaf elements. Each layer contributes to the emergent identity of the whole while maintaining its potential for independent existence. This inherent decomposability enables unprecedented flexibility in how UIs can be deconstructed, modified, and recombined. Integrated with the concept of “Anything-to-Anything”, the IDUI allows for granular and/or finer interactions including interacting with the entire user interface but more importantly down to individual sections, subsections as well as individual pieces of information, e.g., the interaction unit may be a single piece of text or image in the user interface, depending on where the user interacts. The IDUI architecture gives the user full control to interact at any level of information, and areas of intractability are not predefined or restricted.

### Example System Configuration

Figure (FIG. 1 is a block diagram that illustrates a system environment 100, in accordance with one or more embodiments. The system environment 100 includes a software server 110, a dynamic layout software program 120, an executable-routine tool providing server 130 (referred to as “tool provider 130” hereafter), a data storage 140, a user device 150, one or more ML models 160, and a network 170. The entities and components in the system environment 100 communicate with each other through the network 170. In various embodiments, the system environment 100 includes fewer or additional components. In some embodiments, the system environment 100 also includes different components. While each of the components in the system environment 100 is described in a singular form, the system environment 100 may include one or more of each of the components. Different user devices 150 may also access the dynamic layout software program 120 simultaneously.

The software server 110 includes one or more computers that builds a dynamic layout software program 120 which provides a dynamic user interfaces 152 displayed at a user device 150. The content, design, and interaction experience provided by the dynamic layout software program 120 may vary at runtime based on end users' inputs. The software server 110 may use natural language processing (NLP) and machine learning techniques to understand and interpret user intent, generate code, and handle various programming tasks such as identifying preexisting applicable routines, creating functions, defining variables, or implementing logic. In some embodiments, the software server 110 may access a tool provider 130 which hosts one or more existing routine tools, such as microservices, pre-written software module, and software applications.

In one embodiment, the software server 110 may be an automatic content navigation processing system that receives a user input (e.g., text, audio/video signals, or the like) to a user interface. The user input may capture the user's intent (e.g., tasks, queries, goals, needs, etc.). Upon receiving the user input, the software server 110 may enable the user interface to display a set of generative interfaces compiled specifically for the user's needs. The generative interface may be dynamically rendered during runtime of a dynamic layout software program 120. For instance, the content, format, position, user interface (UI) components, etc. of the generative interface may be dynamically generated based on the target content for responding to the user inputs. In some examples, a generative interface may be displayed in the form of a content card or a page. A generative interface may include one or more UI elements, each of which may include content specifying information of the generative interface. In some embodiment, the UI elements may include interactive UI elements that allows users to actively engage with a dynamic layout software program 120 by providing immediate feedback and responses to their actions, creating a dynamic and responsive experience where users can interact with the UI elements, e.g., clicking buttons, selecting options, dragging elements, tactile input with a touch sensitive screen, verbal command, and the like. In some embodiments, a UI element in a generative interface may correspond to a grid that is interactable by a tactile input from a user. When interacted by a user input, the grid and/or the corresponding generative interface may be updated to reflect the interaction, e.g., the grid is accentuated, the other grids in the generative interface are blurred, and the like.

In some embodiments, upon receiving a user input, a software server 110 may enable the user interface to display a set of generative interfaces compiled specifically for the user's needs. The set of generative interfaces may include a mixture of various types of content. In some implementations, a user may determine the combination of content types based on his/her request. By mixing various content types in a single feed, the user may be provided with the content they need from a variety of sources all in one place, thus eliminating the need for the user to navigate back-and-forth between web pages (unless viewing the original web page is their goal). Upon viewing the set of generative interfaces, the user may view and interact with the content. For instance, the user may consume the content, such as reading the text, watching the video, and so on (in place or in a maximized view of the generative interface). The specific interactions a user may perform may vary depending on the type of content (e.g., video content may have a very different set of interactions as compared to a purely textual content). In some embodiments, the user may proceed to obtaining related or follow-up content. For instance, the user may get more content related to a specific generative interface in the feed or they may continue their exploration using one of the generative interfaces as an intermediate step (e.g., a steppingstone).

In some embodiments, the new content based on the user's needs may be displayed in one of two ways: within the current feed: the new content may be injected into the current feed (near the relevant content); and in a new feed: the new content may be presented as a complete new feed of generative interfaces. The user may return to the previous feed at any time. In this way, the software server 110 provides an automatic content navigation method that enables an experience where users can navigate from one content (of any type) to another content (of any type) through a uniform and smooth navigation. The software server 110 provides a more user-centric means of exploring and consuming content-by providing all content (of any type) relevant to the user's intent in a single feed (eliminating the need for visiting web pages or managing multiple tabs)—and enables users to freely navigate through the content with or without explicit follow-up intents, providing a balance between automation and user control. The user does not need to jump between different applications, the applications and the content provided by these applications are automatically gathered and provided to the user in the generative interfaces.

In one embodiment, the software server 110 determines content provided in a user input. The content may include explicit context used to determine user intent and/or content for fulfilling the user intent. In some embodiments, explicit context may refer to information that can be directly extracted from content included in a generative interface, a user input, and/or a user interact with a generative interface, such as specific keywords, phrases, or parameters that clearly define/describe user intents, needs or questions. In some embodiments, the user may interact with a generative interface, and the computer system may also determine the explicit context from the interacted generative interface. The generative interface may be an electronic data file that includes data and metadata. In some examples, a generative interface may be in a form of a content card or a page. From the explicit context, the software server 110 may determine implicit context for generating the target content for a generating the response to the user input. Implicit context may refer to information that may be used to determine user intent or content for fulfilling the user input, but cannot be directly extracted from content included a generative interface, a user input, and/or a user interact with a generative interface. The software server 110 may derive the implicit context based on the explicit context by accessing knowledge databases, user profile, third party data storage, external sources, tool providers 130, ML model 160, etc. The software server 110 also may determine access keys associated with the implicit context. Using the access keys, the software server 110 may access and obtain the required implicit context. The software server 110 combines the explicit and implicit contexts to generate a tailored response that fulfills the user's intent. The response may be presented in a set of generative interfaces for the user to view and interact.

Various servers in this disclosure may take different forms. In one embodiment, a server is a computer that executes code instructions to perform various processes described in this disclosure. In another embodiment, a server is a pool of computing devices that may be located at the same geographical location (e.g., a server room) or be distributed geographically (e.g., clouding computing, distributed computing, or in a virtual server network). In one embodiment, a server includes one or more virtualization instances such as a container, a virtual machine, a virtual private server, a virtual kernel, or another suitable virtualization instance.

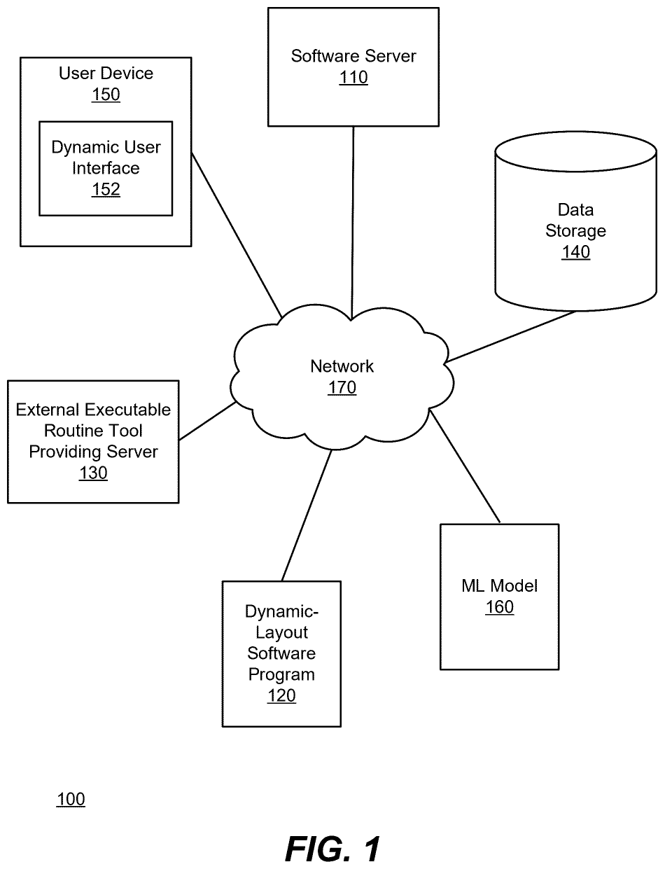

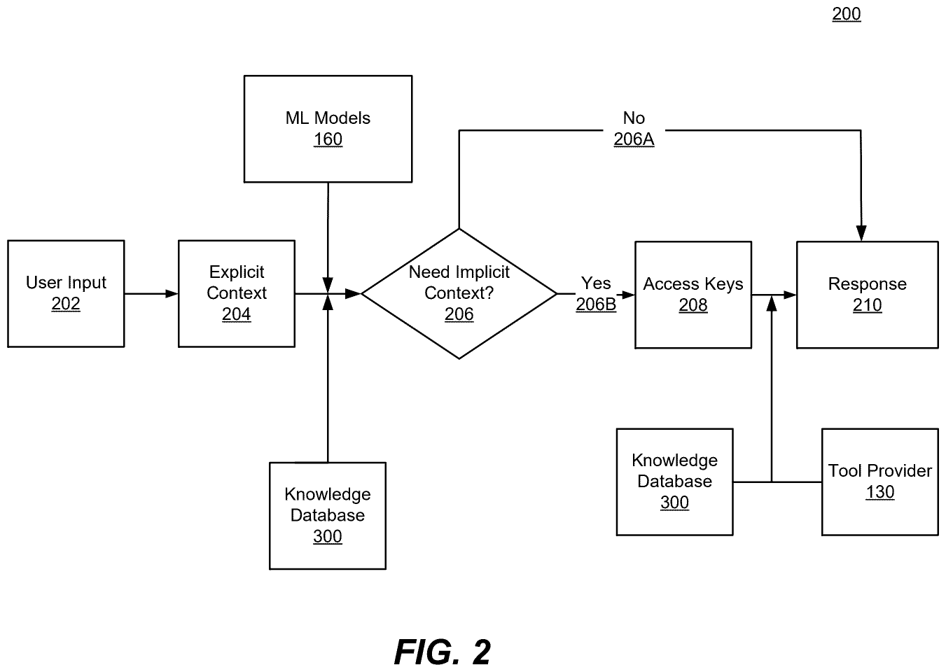

A dynamic layout software program 120 is a software program that is designed to receive end users' input and display a dynamically determined response in a user interface (e.g., dynamic user interface 152). In one embodiment, the dynamic layout software program 120 may not have a fixed user interface layout. In some cases, the dynamic layout software program 120 does not determine its layout until at runtime where an end user provides an input or a command and the dynamic layout software program 120 determines the intent of the end user and the embodiment techniques to be performed to fulfill the intent. The dynamic layout software program 120 may provide a dynamic user interface 152 at an end user device 150 for the end user to input data into the dynamic layout software program 120 and receive output response from the dynamic layout software program 120. Examples of the dynamic layout software program 120 are discussed in further details below with reference to FIGS. 2-10D.

In some embodiments, the dynamic layout software program 120 may be powered by artificial intelligence (AI). In some implementations, the interface of the dynamic layout software program 120 may be directly accessed from the lock-screen of a user device 150 (via interactions with power button, home button, AI button, etc.). A user may start and complete any desired query/tasks without accessing the home screen of any third-party application. A user may start with inputting any text, audio/video signals to the interface. Upon receiving the user input, the dynamic layout software program 120 may apply natural language processing (NLP) to generate NLP signals using combinations of different NLP techniques. Based on the processed user input and NLP signals, the software server 110 may determine a set of predicted intents and determine the content to provide to the user.

The user interface of the dynamic layout software program 120 may be rendering content in real time as the user inputs (e.g., speaking into it). In some implementations, the user interface may render a set of generative interfaces, each of which may be interactable by the user to perform further actions (e.g., complete a transaction, add to a cart, view a video, etc.). For example, a user may tap a generative interface on a touch sensitive electronic display, which directs the user to a different user interface. In some embodiments, the generative interface may include one or more interactable user interface elements, e.g., a user may interact with the words as if they are tabs, buttons, and the like. For different types of content, the generative interface may present the content in different modality, e.g., list, table, calendar, etc.

In some embodiments, the generative interface of the dynamic layout software program 120 may include decomposable UI elements/components. For instance, a user interface/generative interface may include identifiable regions and layout grids for organizing generative interfaces visually. For example, by defining the number of columns and spacing within a generative interface, the software server 110 may define the content and function in each region of the generative interface. Each region may be independent so that when the software server 110 determines a region includes explicit/implicit context, the software server 110 may activate/highlight the corresponding region of the generative interface.

The system environment 100 may include one or more tool providers 130. A tool provider 130 may be a third-party server that is made available to the software server 110. The tool provider 130 may include various executable routine tools such as pre-built software applications (e.g., a music player, a digital map, a stock trading platform), software modules, machine-learning models (e.g., a large language model (LLM)) and/or microservices (identity service, transaction service, etc.) that are available for the software server 110 to use. When the software server 110 executes a dynamic layout software program 120, the software server 110 may identify executable routine tools to be run in the dynamic layout software program 120. In turn, the software server 110 may execute one or more application programming interface (API) calls to request for executable routine tools that are hosted at one or more tool providers 130 to be executed.

In some embodiments, the executable routine tools may be referred to as external executable routine tools. In some embodiments, the external executable routine tools are provided by third-party software providers. In some embodiments, the tools being external does not necessarily require the tools to be operated by a third-party company. Instead, an external executable routine tool may be only external to a dynamic layout software program that refers to the external executable routine tool. Similarly, external sources may be provided by third-party providers. In some embodiments, the sources being external does not necessarily require the sources to be provided by a third-party company. Instead, an external source may be only external to the user interface displayed by user device 150.

A data storage 140 includes one or more computing devices that include memories or other storage media for storing various files and data of the software server 110, and/or the tool provider 130. For example, the data storage 140 stores software developer data, end user data for use by the software server 110 and the tool provider 130. The data storage 140 also stores trained machine-learning models included in the blueprint determination ML model 160. For example, the data storage 140 may store the set of parameters for a trained machine-learning model on one or more non-transitory, computer-readable media. The data storage 140 uses computer-readable media to store data, and may use databases to organize the stored data. In various embodiments, the data storage 140 may take different forms. In one embodiment, the data storage 140 is part of the software server 110 and/or the tool provider 130. For example, the data storage 140 is part of the local storage (e.g., hard drive, memory card, data server room) of the software server 110 and/or the tool provider 130. In some embodiments, the data storage 140 is a network-based storage server (e.g., a cloud server). The data storage 140 may be a third-party storage system such as AMAZON AWS, DROPBOX, RACKSPACE CLOUD FILES, AZURE BLOB STORAGE, GOOGLE CLOUD STORAGE, etc.

A user device 150 may be a device that is operated by an end user of the dynamic layout software program 120. A user device 150 may include a dynamic user interface 152, which receives input and displays output for the dynamic layout software program 120. The user device 150 can be any personal or mobile computing devices such as smartphones, tablets, notebook computers, laptops, desktop computers, and smartwatches as well as any home entertainment device such as televisions, video game consoles, television boxes, receivers, or any other suitable electronic devices. The software server 110 can present information received from executing the dynamic layout software program 120 to an end user, for example in the form of user interfaces (e.g., the dynamic user interface 152). The end user device 150 may communicate with the dynamic layout software program 120 via the network 170. In some embodiments, the user device 150 may include one or more tactile sensors for receiving a tactile input from a user.

The dynamic user interface 152 may take different forms. In one embodiment, the dynamic user interface 152 may be an interface displayed within a web browser such as CHROME, FIREFOX, SAFARI, INTERNET EXPLORER, EDGE, etc. and the dynamic layout software program 120 may be a web application that is run by the web browser. In one embodiment, the dynamic user interface 152 is part of the application that is installed in the end user device 150. For example, the end user device 150 may be the front-end component of a mobile application or a desktop application. In one embodiment, the dynamic user interface 152 is a graphical user interface (GUI) which includes graphical elements and user-friendly control elements.

The ML model 160 is a machine-learning model that analyzes the explicit context and/or user input to determine the implicit context for generating the target content in a user response. In some implementations, the computer system may input the explicit context and the user input to the model and output the implicit context needed to generate the response. In some embodiments, the input to the model may include the generative interface, the interaction with the generative interface, and/or user input. In some embodiments, the ML model 160 may include large language models (LLMs). The ML model 160 may use natural language processing techniques to parse the user input into tokens by breaking the user input into smaller units, such as words or subwords. In some cases, the ML model 160 may include syntactic analysis, named entity recognition (NER), semantic role labeling (SRL), etc. In some embodiments, the ML model 160 may access knowledge databases, external source, tool provider, etc., to obtain information to determine the implicit context and generate the target content. For instance, the software server 110 may access external data sources, e.g., via application programming interfaces (APIs) or other third-party sources to fetch information.

The network 170 provides connections to the components of the system environment 100 through one or more sub-networks, which may include any combination of local area and/or wide area networks, using both wired and/or wireless communication systems. In one embodiment, a network 170 uses standard communications technologies and/or protocols. For example, a network 170 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 170 may be represented using any suitable format, such as hypertext markup language (HTML), extensible markup language (XML), JavaScript object notation (JSON), structured query language (SQL). In some embodiments, some of the communication links of a network 170 may be encrypted using any suitable technique or techniques such as secure sockets layer (SSL), transport layer security (TLS), virtual private networks (VPNs), Internet Protocol security (IPsec), etc. The network 170 also includes links and packet switching networks such as the Internet.

### Dynamic Content Generation

FIG. 2 is a block diagram graphically illustrating a process for dynamic layout software program generating target content upon receiving a user input. As shown in FIG. 2, a user input 202 may trigger a content generation process of a dynamic layout software program 120. The user input 202 may include explicit context associated with the user's query/request/task/intent. In some embodiments, the user's input may be of various types, such as tactile inputs, textual inputs, voice inputs, visual inputs, etc. Tactile inputs are interactions that occur when a user physically touches a device or screen to perform actions. These interactions may involve gestures or touches on surfaces that are designed to detect and respond to physical contact. Tactile inputs may include tapping, long press, swiping, scrolling, dragging, etc. In some implementations, the content from different types of user input may be integrated to form a user query/request. For example, the request received from a user's voice command may be integrated with the content in a generative interface that is interacted by the user. The voice input may be processed by a speech-to-text analysis and converted to text that the computer system can interpret. In one example, the software server 110 may include voice-activated action in generative interfaces so that when the corresponding voice input is processed, the corresponding actions in the generative interface will be initiated/activated. In some implementations, the software server 110 includes real-time voice input processing and dynamic response generation by deploying several scripting languages.

The software server 110 determines the explicit context 204 to generate the user requested content. The explicit context 204 in user input 202 may refer to the information that user has clearly and directly specified in the user input 202. This often involves providing specific details that define the context of the search, for example, location, time, or particular commands (actions), and/or attributes (characteristics). For example, a user may search for “Book a two-bed hotel room on an upper floor near Piccadilly Circus in London for a family of four the week of August 20”. In this example query, the location, audience, time frame, command (or action,) and attribute are all explicitly stated. In some examples, explicit context 204 may also include user intent/request, for example, “How to cook vegan meals for beginners.” Additionally, the explicit context 204 may include parameters that users use to define the scope of their query, such as “Smartphones under $500 with the best camera,” which narrows down the results to meet specific criteria/have the specified parameters.

In some implementations, the explicit context 404 may be not provided from the user's direct input. The user input may also include information provided by user interactions with the user interface of the dynamic layout software program 120. For example, in the process of content generation, the software server 110 may have returned one or more user interfaces (e.g., a series of generative interfaces) to the user, and the user may interact with a displayed generative interface. The software server 110 may identify the information included in the interacted generative interface and use the identified information as the explicit context 204 for generating content. For example, a user may long press a generative interface that displays a product item, the user's interaction with the generative interface (e.g., long press on touch sensitive electronic screen) may trigger a function, for example, causing the software server 110 to add the product item in a shopping cart. In this case, the content in the interacted generative interface (e.g., the product item) may be recognized by the software server 110 as explicit context 204 for generating requested content. In another example, a generative interface may display a meeting invite, and a user may double tab on the touch sensitive electronic screen this generative interface and provide a voice input “send it to ZZZ.” In this case, the software server 110 may identify explicit content 204 from both the generative interface and the user's voice input. The meeting invite in the generative interface is explicit context, and the user's request “send it to ZZZ” and ZZZ included in the user's voice input and interaction with the user interface may also be identified as explicit context 204.

Using the identified explicit context, the software server 110 may identify the user's intent and determine the content to be generated to fulfill the user's intent. In some embodiments, the software server 110 may also access a knowledge database 300 for generating content based on user's request/query. The knowledge database 300 may refer to information of the user device 150, such as hardware, software, overall architecture, and the like. For example, the knowledge database 300 may include knowledge of the user device 150's components, such as processor, memory, storage, display, battery, cameras, sensors, network, etc. The knowledge database 300 may include the operating system, software applications installed, CPU usage, memory allocation, power consumption, and the like. For example, the software server 110 may access the knowledge database 300 and determine that the user device 150 is not connected to networks. In this case, when generating content, the software server 110 will not try to retrieve online information, and instead will use local information. In some embodiments, the knowledge database 300 may include a user profile of a user that includes information of the user. Details of the knowledge database 300 are described in the sections below.

In some example embodiments, in addition to the explicit context identified from the user input and/or interacted generative interface, the software server 110 may determine implicit context for generating the target content. Implicit context may refer to the background information or assumptions that are not explicitly specified in the user input/user interface but are inferred by the software server 110 to better understand and respond to a user input 202. In some embodiments, the implicit context may include data and/or functions for fulfilling a user intent associated with the user input 202. The implicit context 206 may be derived based on the explicit content 204, and derived from various sources, including information from the knowledge database 300, external executable routine tools provided by the tool provider 130, and data or content from the broader environment in which the user input 202 is made. For example, when a user points at a generative interface and speaks “send this to ZZZ.” The explicit context 204 may include the meeting invite in the generative interface, the action “send” and recipient “ZZZ” from the user input. The implicit context may include the method of sending the meeting schedule, such as via message, email, social network, etc. The software server 110 may determine that ZZZ is a colleague of the user, and the most frequently used communication method between the user and ZZZ is via their company email. The software server 110 may determine sending the meeting invite to ZZZ via their company email rather than using chat message, social network, etc.

In some embodiments, the software server 110 may determine the implicit context as the user interacts with a generative interface. For instance, the software server 110 may display a set of generative interfaces in a user interface, each generative interface may include respective content in a respective presentation. The user may view the set of the generative interface and interact with (e.g., via tactile inputs) one or more generative interface in the set. For example, a user may long press a generative interface and the software server 110 may monitor the user's interaction with the generative interface and determine that the interacted generative interface includes explicit context for a user query and may be used to derive implicit context. The software server 110 system may cause the user interface to accentuate the interacted generative interface or regions in the card. For example, the computer system may determine the image of the product is the explicit context and blurs the other generative interfaces that are not interacted by the user. The computer system may determine only a specific region in the interacted generative interface (e.g., only the image of the product) is relevant to the user query (e.g., as explicit/implicit input) and only accentuate this specific region, while blurring the other regions in the interacted card (e.g., text content, interactive elements, etc.).

The software server 110 may determine that the interacted card is one source of explicit/implicit context and receive a user's input (e.g., voice command) as another source. For instance, the software server 110 may cause the user interface to enable further user input, such as voice command, text input, etc. In some embodiments, the user interface of the dynamic layout software program 120 (e.g., generative interfaces) may include decomposable UI structure/element. For instance, the generative interface may have different regions or layers of data structure, for example, an image of the product is in one layer and the associated text may be displayed in another layer. Details of the decomposable UI structure are described in the sections below. In some embodiments, the software server 110 may cause the user interface to dynamically update as receiving the user's input, by highlighting/accentuating regions/layers of the interacted generative interfaces.

In some implementations, the software server 110 may use one or more ML models 160 to determine 206 whether implicit context is needed to generate a response to the user input 202. In some implementations, the software server 110 may input the explicit context 204 and the user input 202 to the ML model 160 and output the implicit context needed to generate the response. In some embodiments, the input to the ML model 160 may include the generative interface, the interaction with the generative interface, and/or user input 202. The ML model 160 may determine the user intent based on the input and identify the target content and target representation for generating a desired response to the user. In some implementations, the ML model 160 may be a trained machine learning model.

In some implementations, the software server 110 may determine 206A that no implicit context is needed, and the explicit context may be directly used to generate the response. Alternatively, the software server 110 may determine 206B implicit context is needed for generating the response. The software server 110 may input the explicit context 204 to the ML model 160 and output implicit context needed and/or one or more access keys 208 associated with the implicit context. The access keys are used for obtaining the implicit context, such as a data object, a path, a password, etc., for accessing and obtaining data. For example, an access key 208 may refer to a password, encryption key, etc., that provides authorized access to secure information. In the example of booking a flight, the access key 208 associated with the home address may be an identifier of the user in the knowledge database 300, the access key 208 associated with the departure airport may be metadata of a location function, and the access key 208 associated with the flight schedules may be an URL to a flight scheduling website. The ML model 160 outputs the implicit context and the associated access key 208, and software server 110 uses the access key 208 to obtain the required implicit context. The software server 110 may use a dynamic content management module to manage the retrieved information. Details of the dynamic content management module are described in the sections below. Based on the explicit context and implicit context, the software server 110 may generate a response 210 to the user input 202, and the response 210 includes the target content. In some embodiments, the explicit context and implicit context may dynamically change as the user interacts with the user interface during runtime of the dynamic layout software program 120.

When analyzing a user input 202 to determine target content for generating a response 210, the software server 110 may use various retrieval mechanisms based on the type of information needed and its storage location (e.g., knowledge database 300, tool provider 130, etc.). For information stored in internal memory levels (e.g., the knowledge database 300), the software server 110 may generate retrieval parameters (e.g., access key 208) to knowledge database 300's structure. These parameters may be intent-matching patterns for intent knowledge to find related historical intents, temporal markers for recency knowledge, or pattern identifiers for domain knowledge, and so on. In some cases, the software server 110 maintains these parameters (e.g., access keys 208) in a structured catalog that defines how to access different types of information and their relationships. In some implementations, the software server 110 caches the access keys 208 at different levels, with cache duration and update frequency determined by the type of information and its typical change patterns. The software server 110 employs predictive retrieval, pre-fetching information likely to be needed based on current context and user patterns. In some implementations, the software server 110 may retrieve information from different knowledge database, data store, external sources, etc. The software server 110 may use parallel retrieval operations through a coordinator that tracks ongoing requests and combines their results. This coordinator may handle timing differences between quick internal lookups and potentially slower external API calls. In some cases, the retrieval process includes error handling and fallback mechanisms. If an external API is unavailable, the software server 110 may fall back to cached data with appropriate freshness indicators. If certain user-specific information is unavailable, the software server 110 may use more general patterns or preferences to maintain functionality.

In some implementations, the software server 110 integrates the retrieved information from various sources to create a complete understanding of the user intent. The software server 110 may include a sequential integration, where the software server 110 integrates information from memory levels (levels in the knowledge database 300) in a defined order. For example, the software server 110 may start with intent knowledge and move through to world knowledge. Each level's contribution builds upon and refines the understanding developed from previous levels. In some implementations, the software server 110 may use a parallel integration, where the software server 110 may activate all memory levels simultaneously, with each level processing a query independently and contributing its perspective to the overall understanding. In some embodiments, the software server 110 may use a hybrid and adaptive integration, where the software server 110 adapts its integration approach based on query characteristics and system conditions. It may begin with parallel processing for initial understanding, and use sequential refinement for specific aspects that need deeper investigation. This flexibility allows the software server 110 to optimize its processing approach for different situations while maintaining consistent understanding capabilities.

### Example Knowledge Database

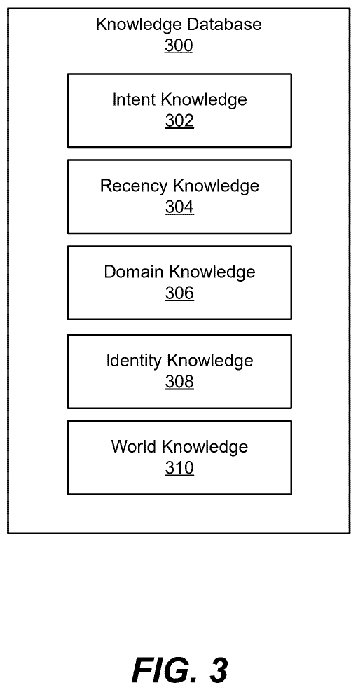

FIG. 3 is a block diagram illustrating an example knowledge database 300, in accordance with one or more embodiments. In some embodiments, the knowledge database 300 may be included in data storage 140. In some embodiments, at least a part of the knowledge database 300 is supported by the software server 110. In some embodiments, the knowledge database 300 may be implemented through a combination of specialized databases, caching systems, and connections to external sources. In one example embodiment, as shown in FIG. 3, the knowledge database 300 may be organized in five levels, such as, an intent knowledge 302, a recent knowledge 304, a domain knowledge 306, an identity knowledge 308, and a world knowledge 310. The first four levels may represent different aspects of user-specific memory (e.g., knowledge database), and the fifth level may be configured to provide broader world knowledge. Each level of the knowledge database 300 may capture different types of information and operate at different granularities and update frequencies, and each level may require different storage and access patterns based on the respective update frequency and the types of information maintained. While these levels/components are listed as examples that may be included in a knowledge database 300, in various embodiments, a knowledge database 300 may include fewer, additional, or different levels/components.

In one embodiment, the intent knowledge 302 stores connections between related intents across interactions. This level identifies and tracks relationships between similar or connected user intentions over time. While the intent knowledge 302 may contain less information volume compared to other levels, the intent knowledge 302 builds continuity between related user goals and queries, even when occurring across different sessions or time periods. In one example, the intent knowledge 302 is implemented using specialized data structures that focus on capturing and maintaining these intent-based connections. For example, the software server 110 may use semantic analysis and pattern matching to identify when a current query or action relates to previous intents, e.g., complex, multi-session tasks where users may return to continue previous activities.

The recent knowledge 304 provides context from the user's recent activities and interactions beyond the current session. In some embodiments, the software server 110 may group consecutive user interactions with the dynamic layout software program 120 as a user session. The software server 110 may assign timestamps and define interaction time intervals to determine a user session. Information associated with a user session and/or metadata describing the user session may be stored at data storage 140. In some embodiments, each user session may be identified by a session identifier. The recent knowledge 304 tracks and organizes information about recent searches, viewed content, and interactions across different contexts. In some cases, the software server 110 may use a combination of short-term storage and efficient indexing to maintain quick access to recent historical data. For instance, the software server 110 may use a temporal decay mechanism for the information stored at the recent knowledge 304, where information gradually transitions through different stages of recency. Recent interactions are stored with detailed context, while earlier interactions may retain only the key patterns or outcomes.

The domain knowledge 306 stores user patterns and preferences within spheres of interaction. The domain knowledge 306 may include structured databases that organize information by domain or activity type, which allows for efficient retrieval of patterns and preferences relevant to specific types of queries or actions. In some embodiments, the software server 110 may implement domain recognition and classification mechanisms to categorize incoming information. The software server 110 identify relationships that map between domains to understand how preferences in one area may influence understanding in another. The identified relationships between the user patterns, preferences, domain, etc. are stored in the domain knowledge 306. In some cases, the domain knowledge 306 may be updated periodically, based on the amount of user interactions, etc. In some cases, the domain knowledge 306 may be updated less frequently and focus on established patterns rather than individual interactions.

The identity knowledge 308 stores information of a user as a whole person, beyond their interactions with specific domains or systems. In some implementations, the identity knowledge 308 stores complex relationships between different aspects of user behaviors and preferences. For instance, the identity knowledge 308 may identify and store patterns of user behaviors and preferences that persist across different contexts. In one example, the identity knowledge 308 may use models of user behavior to predict a user's behavior in new situations. The identity knowledge 308 may be updated gradually as new patterns emerge while maintaining stability in core user characteristics.

In one embodiment, the identity knowledge 308 may maintain a user profile of each user that interacts with the dynamic layout software program 120. The user profile may include information related to user's behaviors, preferences, etc. The identity knowledge 308 may build the user profile by collecting and analyzing various types of data from the user's interaction with the dynamic layout software program 120, the software server 110, other various computing devices, online data, social media accounts, etc. For example, the user profile may include demographic information, such as age, gender, and location, which can be gathered from app usage, location data, or account settings. The user profile may also identify behavioral patterns, such as how the user engages with their device. This includes data on app usage, such as which apps are accessed, how often, and for how long. It may also include browsing history, communication patterns in calls, messages, and emails. Additionally, media consumption habits, like the types of music, videos, or podcasts the user enjoys, contribute to understanding their entertainment preferences. The user profile may include personal interests and preferences, such as shopping habits and preferred online platforms. The user profile may include location and mobility data, health and fitness data, financial information is another critical aspect, including transaction history from mobile banking apps or digital wallets.

In some embodiments, the identity knowledge 308 may store the user profile as a data store that includes the user profile data and is accessible to the software server 110 for data retrieval. Alternatively, the user profile may be a catalog specifying the available information of the user, the storage location of the information (e.g., data storage 140 or other devices), and the path/method to retrieve the information. In some embodiments, the user profile may be a mini user profile as it may just include recent information for the user in order to keep the size of the profile manageable and to the most relevant current details.

The world knowledge 310 combines access to both static knowledge bases and dynamic external sources. The “static knowledge bases” are about non-user information, e.g. a recipe database, external data stores, internet (through APIs), LLMs (training data), etc. The world knowledge 310 may include connections to language models (e.g., ML models 160) for fundamental understanding, as well as interfaces to various external APIs (e.g., tool provider 130) and data sources for real-time information. In some implementations, the world knowledge 310 may act as an interface to various knowledge sources without storing information at a local data store. The world knowledge 310 may include a caching mechanism for frequently accessed information while ensuring real-time data remains current.

When retrieving information from the knowledge database 300, the software server 110 may vary the retrieval mechanisms based on the levels. In some implementations, the software server 110 may access the intent knowledge 302 using semantic matching and/or pattern recognition to identify and retrieve previously connected intents so that the software server 110 maintains continuity across related interactions regardless of when they occurred. The software server 110 may access the recent knowledge 304 for temporal queries which may locate and correlate recent activities. The software server 110 may access the domain knowledge 306 based on pattern matching with semantic search to identify relevant behaviors and tendencies within specific domains of activity, and access the identity knowledge 308 based on potential user behaviors and/or preferences that may influence the current intent. When accessing the world knowledge 310, the software server 110 may coordinate between multiple external sources which involves connection pools for different APIs. The software server 110 may manage authentication and rate limits and handle various data formats. For instance, the software server 110 may use a registry of external sources that tracks their capabilities, access requirements, and data freshness parameters.

### Dynamic Content Management

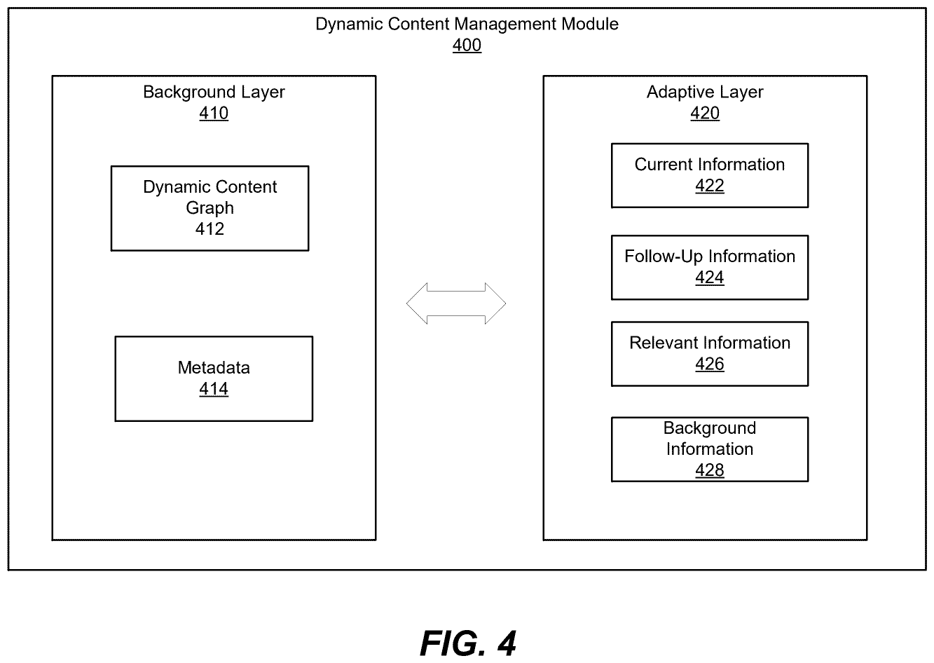

FIG. 4 is a block diagram illustrating a dynamic content management module 400, in accordance with one or more embodiments. In some embodiments, the software server 110 may include a dynamic content management module 400 for managing the retrieved information. In some embodiments, at least a part of the dynamic content management module 400 is supported by the software server 110. In one embodiment, as shown in FIG. 4, the dynamic content management module 400 may include a background layer 410 and an adaptive layer 420. The background layer 410 may maintain the retrieved information as a graph with nested and linked relationships and the adaptive layer 420 may further analyze and select the retrieved information based on the user input and context. While these components are listed as examples that may be included in a dynamic content management module 400, in various embodiments, a dynamic content management module 400 may include fewer, additional, or different components.

In some embodiments, the dynamic content management module 400 may organize the retrieved content in a dynamic content graph 412. The dynamic content graph 412 includes a plurality of nodes, each node may represent a piece of retrieved information/content and the edges between the nodes represent relationships of the corresponding nodes. The nodes may form a hierarchical structure, representing information at various levels of granularity. For example, for a cooking related query, the dynamic content management module 400 may build a cooking related dynamic content graph 412 where a recipe node may contain nested nodes for ingredients, preparation steps, and nutritional information. The recipe node may be linked to cooking technique videos, ingredient substitution guides, or user reviews. Each piece of information maintains its individual identity while being part of a larger, interconnected web-like graph of knowledge. The dynamic content graph 412 may update according to the retrieved information in response to the user's consecutive inputs, and maintain an active understanding of the information space throughout a user session.

In one embodiment, the dynamic content graph 412 may include metadata 414 describing the dynamic content graph 412 and the nodes and edges included in the dynamic content graph 412. The dynamic content graph 412 may be organized using an attention mechanism similar to a transformer attention mechanisms in machine learning. In one example, the metadata 414 may include a first type of metadata that describes a node's characteristics (acting as a key-like structure in an attention mechanism). The first type of metadata may describe how a piece of information understands its own nature and purpose by representing what information it contains. For example, a first type of metadata of a recipe node indicates that the recipe node includes a cooking instruction, a difficulty level, cuisine type, and other intrinsic properties of the recipe node. In another example, the metadata 414 may include a second type of metadata that describes connections of a specific node with other nodes in the dynamic content graph 412 (another key-like structure in an attention mechanism). For instance, a second type of metadata for a recipe node may indicate relationships to nodes that represent information of cooking technique guides, video tutorials, similar recipes and the like. In another example. The metadata 414 may include a third type of metadata, which describes quantitative metrics corresponding to information provided by each node (acting as a value-like structure in an attention mechanism). For instance, a third type of metadata for a recipe node may include metrics such as number of ingredients, length of instructions, image dimensions, and types of information, i.e. text, image, etc. In this setting, the current and past user queries in a session correspond to the query-like structure in attention mechanism.

The metadata 414 and the dynamic content graph 412 evolve as users interact with the content. In some embodiments, the software server 110 may dynamically update the background layer 410 to maintain an active understanding of information relevance. In one embodiment, the software server 110 may dynamically score the retrieved information based on the relevance of the context. In one example, the context relevance of each piece of retrieved information may be scored in a plurality of dimensions. For instance, the software server 110 may score the retrieved information based on a contextual depth, e.g., how relevant the information is to the immediate user input/query. For example, for a user researching renewable energy with solar panels, information about photovoltaic technology may be in immediate relevant, while manufacturing processes remain in a supporting context, and general energy policy stays in the background. The contextual relevance of the information may be dynamically updated based on further user input/interaction with the information, e.g., the less relevant information may evolve as more relevant if the user's exploration heads in that direction. In another example, the software server 110 may score the retrieved information based on strength of the relationship of the information. The software server 110 may track both explicit relationships (e.g., citations between papers) and implicit relationships (e.g., discovered through user behavior). The software server 110 may determine implicit relationships and the corresponding strength of relationships based on behavior patterns, frequencies, etc. In another example, the score of retrieved information may temporally evolve. Relevance scores may be not static but evolve with user interactions. If a user exploring camera reviews frequently returns to low-light performance discussions, related content about sensor technology and night photography may gradually gain stronger relevance scores in this context.

In some embodiments, the dynamic content graph 412 may be organized using an attention mechanism. When receiving a user query Q, the software server 110 may calculate a score Aᵢ for each node and edge in the dynamic content graph 412 with respect the query Q using a formular,

$${A}_{i} = \frac{{QK}_{i}}{\sqrt{{d}^{2}}} ,$$

here, d is the vector dimension, Kᵢ represents the key-like metadata for each node. If a certain node Ni has a high score, its neighboring nodes may be relevant too. For instance, the score of node Ni may be Nᵢ=Aᵢ+ΣⱼeⱼAⱼ, here, eⱼ represents the edge weight between Nᵢ and neighboring node Nⱼ. Therefore, the software server 110 may broadcast each node's score to neighboring nodes relative to the edge scores, thus slightly increasing their scores too.

In some embodiments, the software server 110 may define a target information density (I_{target}) which describes an amount of information to present to the user. The target information density may depend on screen size, width to eight ratio, font size, etc. To select n relevant nodes while maintaining readability, the software server 110 may select nodes such that:

$${\sum }_{i = 1}^{n} {A}_{i} {V}_{i} < {I}_{target} ,$$

here, Vᵢ represents the value-like metadata for each node, e.g., the value of the information in node Nᵢ (e.g, text length, image size, etc.). In some embodiments, the software server 110 may determine a relevance threshold A_{target} to filter out low-relevance content. If a node's score Aⱼ is not less than the relevance threshold A_{target}, the information of the node may be included as current information in a first plain as described below. For a new user query, the software server 110 may update the scores for all existing nodes and compute attention for new information. Instead of replacing scores, the software server 110 may perform a weighted update, New Scoreᵢ=Aᵢ₁+kAᵢ₀, here, Aᵢ represents score from a new query, Aᵢ₀ represents the previous score from a previous query, and k is the weighting factor based on query similarity. In this way, if few nodes change, the software server 110 may inject new information into the current generative interface (e.g., hiding/summarizing less relevant content). If many nodes changes, the software server 110 may generate one or more new generative interfaces to display the updated content.

The adaptive layer 420 determines how the information is processed by the software server 110 and presented to the user via the dynamic layout software program 120. In some implementations, when processing the retrieved information, rather than simply filtering, selecting, etc., the software server 110 uses the adaptive layer 420 to determine which and how the retrieved information is used. The adaptive layer 420 may include multiple “focal planes” that focus on different depths/aspects of the retrieved information. For instance, the adaptive layer 420 may include a first plane that includes current information 422, a second plane that includes follow-up information 424, a third plane that includes relevant information 426, and a fourth plane that includes background information 428.

The current information 422 contains information that directly addresses the user's current focus. For instance, when a user asks about a specific cooking temperature of a recipe, the current information 422 may show the temperature and the critically related information like cooking time and any temperature variations throughout the process. The follow-up information 424 holds information that, while not directly requested, is likely to be valuable for immediate follow-up user input/query. In the recipe example, the follow-up information 424 may include common problems users encounter with temperature control for this specific dish, or how to adjust the temperature for different types of ovens. The relevant information 426 maintains background context-information that becomes relevant as the conversation evolves. For example, the relevant information 426 may include alternative cooking methods, related recipes, or seasonal variations of the dish in the recipe example. The background information 428 may include information that, while initially retrieved, has become less relevant to the current context. For instance, if the conversation has focused specifically on the cooking process, general information about the recipe's history may be moved to the background information 428.

In some embodiments, the interaction between the user and the software server 110 (via the dynamic layout software program 120) functions like a conversation where both participants actively engage in understanding and responding to each other's intentions and needs. When the dynamic layout software program 120 receives a user input, the software server 110 may retrieve relevant information and generate a background layer 410 by integrating any existing information and the retrieved information. Each new piece of information is analyzed and connected to existing nodes based on their metadata relationships. The software server 110 may use the adaptive layer 420 to distribute the information on the focal planes. The software server 110 may process user interactions and evolving queries while maintaining awareness of the entire conversation context through the background layer 410. When a user interacts with any piece of information, such as, a direct click, a follow-up question, or a reference in conversation, the software server 110 uses these interactions to update its understanding of user intent and adjust the information landscape (e.g., the background layer 410 and/or the adaptive layer 420) accordingly.

The software server 110 dynamically manages content visibility and introduction through fluid transitions that maintain user context and understanding. As new content becomes relevant, it may smoothly expand between related sections, fade into view alongside current content, or seamlessly integrate within the existing view. Similarly, less relevant content may softly fade or gracefully collapse to maintain focus while remaining accessible, e.g., a section minimizing to just its heading when attention shifts elsewhere.

The decision between injecting content into the current view (e.g., generative interface) versus creating a new view (e.g., one or more new generative interface) depends on both relationship strength and cognitive continuity. Closely related content that enhances current understanding may slide into view within the current context, while content that represents a new exploration direction might transition to a fresh view while maintaining visible connections to its origin. The software server 110 may progressively reveal content detail, e.g., starting with a summary or preview that can expand in place as the user's interest grows.

Throughout these transitions, the software server 110 maintains spatial consistency and relationship clarity. Content does not simply appear or disappear. The content (displayed in the generative interface) transforms in ways that help users understand where it came from and how it relates to what were displaying. These smooth transitions help users build a mental map of how different pieces of information connect, making it natural to move back and forth between related content as their exploration evolves.

### Decomposable User Interface

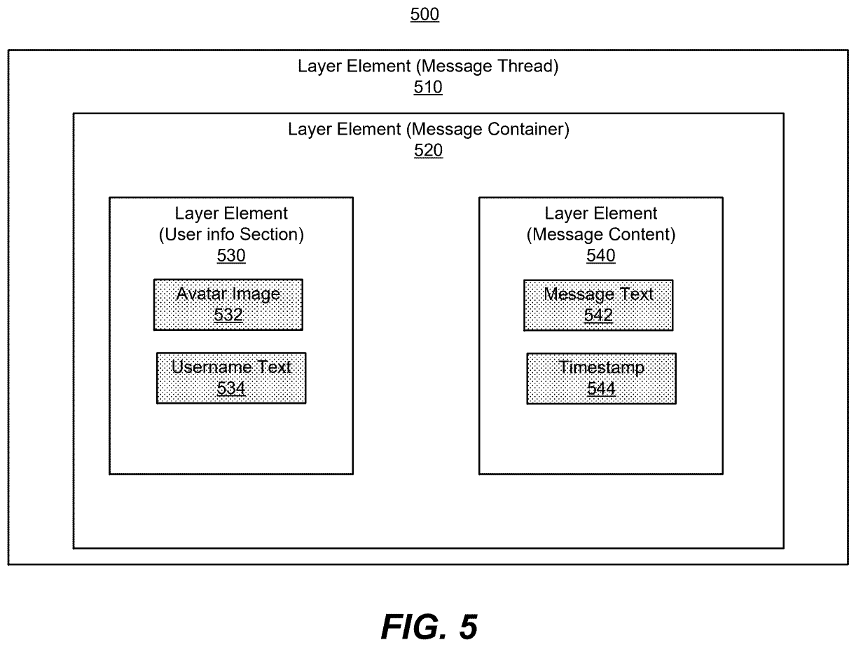

FIG. 5 is a block diagram illustrating an example inherently decomposable user interface (IDUI) 500, in accordance with one or more embodiments. In some implementations, the software server 110 may generate an IDUI architecture for the generative interface of the dynamic layout software program 120. An IDUI may include components that are decentralized across concentric layers of functionality. In FIG. 5 the IDUI 500 may include at least two types of components, units of decomposability and units of non-decomposability. The units of decomposability may form as layer elements in the IDUI 500, such as, message thread 510, message container 520, user info section 530, and message content 540 in FIG. 5. The units of non-decomposability may form as leaf elements in the IDUI 500, such as, avatar image 532, username text 534, message text 542, and timestamp 544 in FIG. 5. Each layer element may either have no parent layer (the root layer) or exactly one parent (an intermediate layer) and wraps one or more children (lower layers), forming a tree-like structure that eventually terminates in leaf elements. Each layer element maintains its own complete set of properties, state, behavior, and appearance making it self-sufficient and capable of functioning independently even if inner or outer layer element are removed or modified. The leaf elements (e.g., avatar image 532, username text 534, message text 542, and timestamp 544 in FIG. 5) may form the lowest levels of the UI tree, and are not further decomposable. The leaf elements may be used to include/display basic data/content, as texts, images and the like.

In one example embodiment, the IDUI 500 may include metadata describing a structure of the layer elements. The metadata may include parent metadata which captures information regarding shared boundaries between a layer element and its immediate parent layer element. The metadata may include child metadata that captures information regarding the shared boundary between the layer and its immediate child elements. The metadata may also include layer metadata which captures information of the layer element independent from the parent and/or child elements. Unlike traditional UI development, where programmers conceptualize components as cohesive units with a singular, centralized identity, the IDUI architecture 500 proposes a layered approach where component identity is decentralized across concentric layers of functionality. Each metadata in the IDUI 500 may define interfaces for state/logic passing, describe identity (for the respective layer element) or expectations (for immediate parent/child element), among other information that enables a layer element to be reused in the right contexts with appropriate parent/child elements. In this way, the generative interface may be inherently decomposable such that any component/section of the UI can be extracted without recurring or modification, reused in new contexts without adaption, modified independently of its original context, and recombined without other elements seamlessly. This property exists not because of careful design or specific coding patterns, but because it is fundamental to how the IDUI format represents UI elements. The UI's identity emerges from the nested composition of autonomous layers rather than being predefined as a monolithic unit, and modifying or removing any single layer transforms the UI's identity-which may be subtle or a dramatic change-without affecting the integrity and functionality of the remaining layers.

In some example embodiments, a layer element may be defined such that the layer element may only be reused with parent/child elements that supply all required state/logic at the boundaries. In this case, the metadata of the parent/child element need to closely match those of other layer elements to connect the layer elements. Alternatively, the layer element may be structured organizing state and logic in sections along with parent dependencies. In this way, different layer elements may be connected even if they do not include all required state/logic.

When re-using an existing layer element in generating a new UI, the software server 110 may adapt the existing layer element to connect with the corresponding parent/child elements in the new UI. For instance, the software server 110 may include metadata “adaptation_area” between the boundaries of layer elements. This metadata defines a logic that may connect state/logic named one thing in the parent layer element but another thing in the child layer element. In some cases, this metadata may define new state/logic that the parent layer element does not include.

When generating an IDUI 500, the software server 110 may generate one layer at a time so that each layer element is complete and self-sufficient before proceeding to the corresponding child element. In some implementations, the software server 110 may use a top-down approach (e.g., starting with a higher layer and progressively defining child layer elements until reaching leaf elements); alternatively, the software server 110 may use a bottom-up approach (e.g., beginning with leaf elements and building upward by creating containing layer elements). When generating a new UI, regardless of direction, the software server 110 begins by defining the core purpose, properties, and interface specifications of each layer element. For example, when generating a message thread 510 interface, the higher layer element 510 may establish the basic container 520 that handles the overall message flow and updates. This layer element 520 may be complete enough to function independently, capable of managing message data and updates even if the specific ways messages are displayed change.

As the software server 110 proceeds to generate each child layer element, the software server 110 may keep strict adherence to interface boundaries between the layer elements. Each new layer element may be generated with complete knowledge of the corresponding parent layer element's interface specifications. The new layer element is designed to function independently. Consider generating the individual message display layer element (e.g., user info section 530 or message content 540) within the message thread 510. This layer element would define how a single message is structured and displayed, managing its own state (like whether the message is expanded or collapsed) while also specifying how it receives message content from its parent layer element and how it will structure any child elements like the avatar image 532, username text 534, message text 542, and/or timestamp 544.

The software server 110 may complete the generation of the IDUI 500 by either reaching natural leaf elements such as text or images, or by incorporating pre-built, traditional components. When incorporating traditional components, the software server 110 treats them as leaf elements, wrapping them with interface specifications to integrate with the inherently decomposable layer elements above them. This hybrid approach allows the software server 110 to leverage existing component libraries while maintaining the decomposability of the IDUI architecture for higher-level layers.

In some embodiments, the software server 110 may store the previously generated layer elements and UI components in a database, e.g., a data storage 140. When generating a new layer element, the software server 110 may search the database for similar existing implementations to determine whether to reuse one or more layer elements from the database. The software server 110 may analyze the interface specifications and adaptation requirements of the identified layer element and/or UI component to determine if they can be effectively reused in the new context. In some embodiments, the software server 110 may not identify an existing layer element or a UI component to reuse, or the software server 110 may determine that adapting an existing layer element may require extensive modifications, the software server 110 may generate a new layer element. The software server 110 may analyze the existing layer element to identify the differences between the existing layer element and the newly created layer element and determine information for the software server 110 to generate more versatile and reusable layer elements.

In some embodiments, the software server 110 may generate IDUIs for a dynamic layout software program 120 in real time. The software server 110 may start with generating essential layered structure with just sufficient specifications for proper rendering and basic layer independence. This enables rapid UI generation and immediate usability without compromising the fundamental decomposability of each layer element. The software server 110 may generate more detailed metadata specifications for each layer element in a post-processing step, which may occur either behind the scenes or after the initial UI is live. This separation of concerns prevents unnecessary latency in the primary generation process while still enabling all advanced capabilities like real-time editing and layer extraction. The generated UI may integrate with appropriate rendering logic based on a target platform and requirements, maintaining both its visual representation and decomposable structure throughout its lifecycle.

### Process of Deriving Context

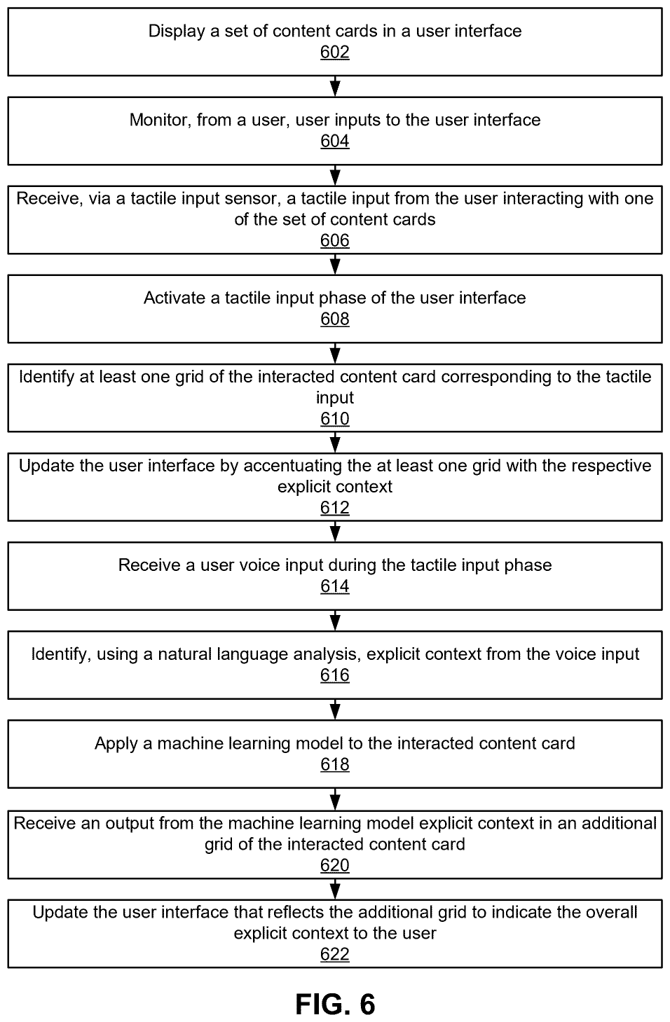

FIG. 6 illustrates an example process 600 for deriving context in a dynamic layout software program, in accordance with one or more embodiments. For the particular embodiment discussed in FIG. 6, the software server 110 and the tool providers 130 are different servers and operate independently. For example, the software server 110 includes one or more computers. A computer associated with the software server 110 includes a first processor and first memory. The first memory stores a first set of code instructions that, when executed by the first processor, causes the first processor to perform some of the steps described in the process 600. The tool provider 130 uses different hardware and includes a different computer (or one or more computers) that includes a second processor and second memory. The second memory stores a second set of code instructions that are different from the first set of code instructions. For example, the second set of code instructions may be developed independently using even a different programming language. The second set of code instructions, when executed by the second processor, cause the second processor to perform other steps described in the process 600. While two independent servers are described as an example architecture associated with the process 600, in some embodiments a single server can also perform the entire process 600.

As shown in FIG. 6, the software server 110 displays 602 a set of generative interfaces in a user interface. The user interface may be a dynamic user interface 152 provided by dynamic layout software program 120 and the dynamic user interface 152 is displayed at a user device 150. The dynamic user interface 152 may include one or more IDUIs. Each generative interface may include one or more grids, and each grid may contain explicit context specifying information of the generative interface. One or more grids of the generative interfaces may correspond to a UI component (e.g., a layer element or a leaf element) in the IDUI. The software server 110 may monitor 604, from a user, user inputs to the user interface. The user inputs may include at least a tactile input from the user. The software server 110 may receive 606, via a tactile input sensor, a tactile input from the user interacting with one of the set of generative interfaces. The software server 110 may activate 608 a tactile input phase of the user interface. The tactile input phase dynamically generates responses during runtime of receiving user inputs to the user interface. The software server 110 may identify 610 at least one grid of the interacted generative interface corresponding to the tactile input. The software server 110 may update 612 the user interface by accentuating the at least one grid with the respective explicit context. The software server 110 may receive 614 a user voice input during the tactile input phase. The software server 110 may identify 616, using a natural language analysis, explicit context from the voice input. The software server 110 may apply 618 a machine learning model to the interacted generative interface. The explicit context from the at least one grid of the interacted generative interface and the explicit context from the voice input. The software server 110 may receive 620 an output from the machine learning model explicit context in an additional grid of the interacted generative interface. The software server 110 may update 622 the user interface that reflects the additional grid to indicate the overall explicit context to the user.

In some embodiments, the software server 110 may display a first set of generative interfaces in a user interface. Each generative interface may include one or more user interface elements, and each user interface element may contain content specifying information of the generative interface. The software server 110 may monitor user inputs to the user interface, and the user inputs may include at least a user interaction from a user with one of the one or more user interface elements. Responsive to receiving the user interaction with a user interface element in a generative interface, the software server 110 may activate a dynamic input phase of the user interface. The dynamic input phase dynamically generates responses during runtime of receiving user inputs to the user interface. The software server 110 may update the user interface by accentuating the user interface element that is interacted by the user. The software server 110 may receive a second user input during the dynamic input phase and identify content from the second user input using a natural language analysis. The software server 110 may apply a machine learning model to the generative interface comprising the interacted user interface element, the content contained in the interacted user interface element and the content from the second user input. The software server 110 receives content as an output from the machine learning model and updates the user interface to display a second set of generative interfaces. The second set of generative interfaces may include one or more runtime-determined user interface elements, and each runtime-determined user interface element include information associated with the received content.

### Example Dynamic Layout Software Program

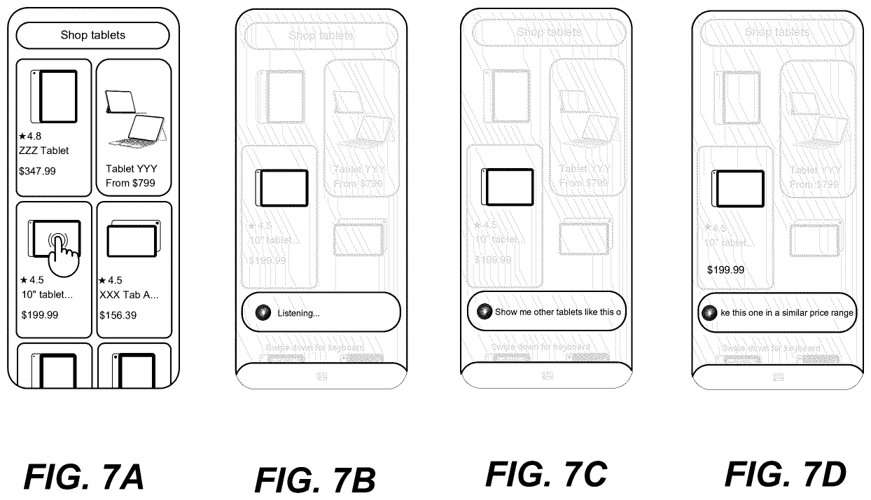

FIGS. 7A-10D illustrate various example user interfaces for a dynamic layout software program, in accordance with an embodiment. The user interfaces may be a dynamic user interface 152 provided by the dynamic layout software program 120 of the software server 110. The dynamic user interface 152 may be displayed by a client device 150. In some embodiments, the example user interface may be displayed by a webpage browser, a mobile application, etc.

As shown in FIG. 7A, the user interface may display a set of generative interfaces to a user and the user may interact with one or more of the generative interfaces via a tactile input. The software server 110 receives the user's tactile input and activates a tactile input phase of the user interface in FIG. 7B. The software server 110 identifies at least one grid of the interacted generative interface corresponding to the tactile input. As shown in FIG. 7B, the software server 110 identifies one or more grids corresponding to a tablet item based on the tactile input and the UI component displaying the tablet is lightened up and the other content in the same content as well as the other contents cards in the user interface become blurry and fade into the background. Activating the tactile input phase may include enabling the user interface to receive voice input from the user, e.g., “listening” as shown in FIG. 7B. The software server 110 receives the user's voice input, e.g., “show me other tablets like this one in a similar price range” as shown in FIG. 7C and FIG. 7D. The software server 110 may identify explicit context from the voice input and generate response to the voice input based on the identified explicit context and implicit context. The software server 110 displays the response in the user interface via the client device, as shown in FIG. 7D.

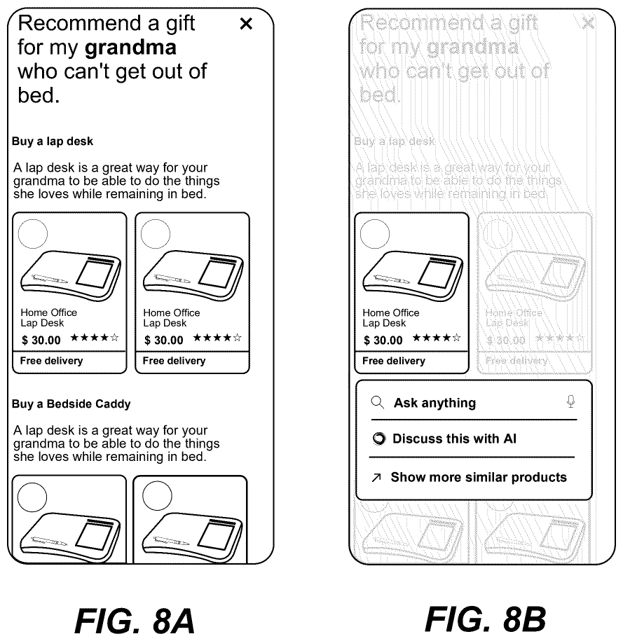

FIG. 8A shows an example set of generative interfaces displayed in a user interface. Unlike traditional search results, this set of cards may include a mixture of various types of content (and, correspondingly, different types of contents cards) in a single feed, and the combination is not predefined. In some embodiments, a user may determine the combination of content types based on his/her request. By mixing various content types in a single feed, the user may be provided exactly with the content they need from a variety of sources all in one place, thus eliminating the need for the user to navigate back-and-forth between web pages (unless viewing the original web page is their goal). The user may have a very specific idea of what content they wish to get with respect to one of the generative interfaces in the feed (e.g., if they want to see reviews for a specific product), the user may interact with the generative interface via the user interface, e.g., long-pressing on the generative interface (or perform an equivalent interaction). The software server 110 may enable the user interface to provide a view that allow the user to describe/input their new intent. There may also be a set of recommendations for follow-ups that the user can pick from, shown in FIG. 8B as an example.

In some embodiments, the software server 110 guides content exploration through subtle indicators that reveal connections and pathways between different pieces of information. For instance, visual treatments like gentle highlights or understated animations suggest when content contains paths to related information, with different treatments indicating the nature of these connections, e.g., whether it is a deeper dive, related concept, or practical application. When users interact with content, the software server 110 reveals more explicit connection points through contextual indicators that preview where each path may lead. These may appear smoothly around the interaction point, giving users a sense of what related content is available without disrupting their current context. This preview helps users understand how different pieces of content relate to what they are currently viewing, making exploration feel natural and purposeful. The software server 110 provides a generative interface where movements between related content flow intuitively. Rather than presenting navigation as a separate layer of the interface, it becomes an integral part of how users interact with content itself, with each piece naturally suggesting paths to discover related information that might interest them. In some embodiments, the software server 110 takes account of the user's current context and previous interactions to anticipate likely exploration paths. For instance, if a user has shown a pattern of focusing on practical implementation details rather than theoretical foundations, the software server 110 may prioritize making practical information more readily accessible while maintaining theoretical information in a secondary context.

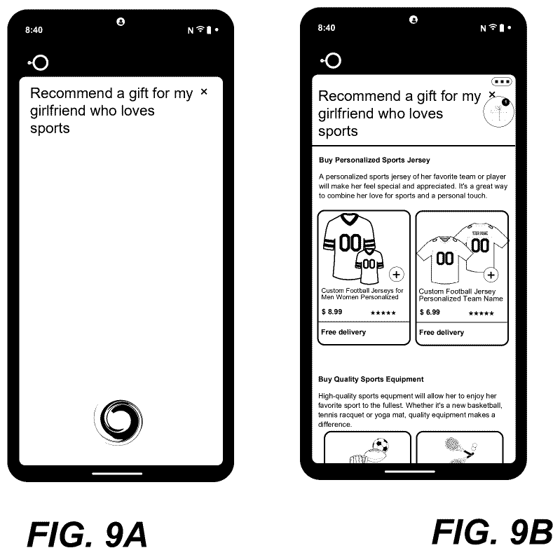

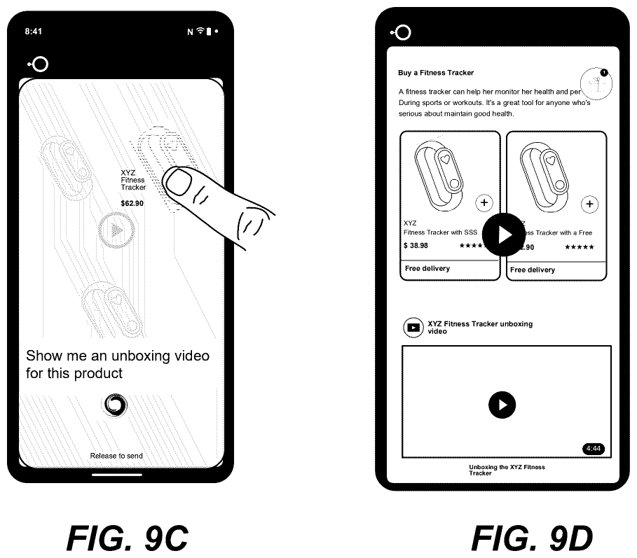

In one example, as shown in FIG. 9A, a user may input a query to the user interface, e.g., “Recommend a gift for my girlfriend who loves sports.” Upon receiving the input, the software server 110 may determine the content/entity/intent based on the input, and perform a task to fulfill the user's intent. For example, in this example, the software server 110 may determine to perform a search to provide search results as a response to the user query. As shown in FIG. 8B, the interface presents a set of generative interfaces with contents from various sources. Each generative interface may be interactable by the user. For example, in FIG. 9B, the user may tab a generative interface and directly add a product into a shopping cart.

In some embodiments, the user interface may be used to further generate additional user interfaces, e.g., a set of generative interfaces leads to the generation of another set of generative interfaces. For example, the user may further interact with a generative interface to input further information (e.g., query, task, etc.) and/or to obtain additional relevant information/content. As shown in FIG. 9C, a user may press a generative interface that include the content that the user is interested in, and provide further input to the interface, e.g., continue speaking into it. For example, the user may say “show me an unboxing video for this product.” The interface receives this input and generate relevant content based on the input (as shown in FIG. 9D). A second set of generative interfaces may be presented right next to the pressed generative interface. In this way, the user does not need to jump between different applications to do it, reducing the user's extra effort.

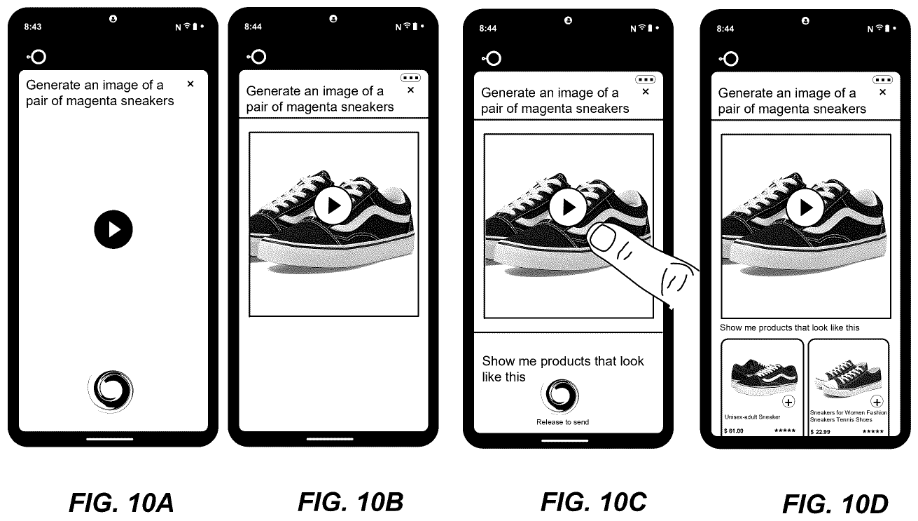

In another example, depending on the user input, the configuration may provide generative content as needed. For example, as shown in FIG. 10A, a user may not have a real product in mind, and input to the generative user interface, e.g., “generate an image of a pair of magenta sneakers.” Receiving the user input, the computer system may utilize various models and external knowledge/database to generate target content in a target representation. In one example, the software server 110 may extract explicit context, determine user intent, identify implicit context, and generate the response to the user input. The software server 110 may determine the user input include explicit context, e.g., generating an image (i.e., a function) and a pair of magenta sneakers (i.e., data). The computer system may apply a model to the explicit context and determine that implicit context is needed, and the implicit context may include deploying an image generation tool. For example, the software server 110 may identify that the user has an image generation tool installed in the user device 150. The trained model may output an access key (e.g., a password to the account of the image generation tool, and/or an API call to execute the image generation tool) associated with the implicit context. Using the explicit context and implicit context, the software server 110 may generate a response that fulfills the user's intent, e.g., an image as user required (in FIG. 10B). The software server 110 may enable a generative interface to present the image in a generative interface to the user. The generative interface is interactable, including interactive interface element. For example, in FIG. 10C, the user may press the sneakers and speak into the interface, e.g., “show me products that look like this.” In this case, the software server 110 may identify explicit context from both the interacted generative interface and the user input, e.g., “sneakers,” “magenta,” “products,” “look like,” etc. Based on the identified explicit context, the software server 110 may derive implicit context. For example, the software server 110 may determine that the implicit context includes a search function, online information of shoe stores, the user's favorite shopping platform, user account, etc. The software server 110 may use the explicit context and implicit context to generate a response, e.g., performing search actions and provide search results to the user request (as shown in FIG. 10D).

### Example Machine-Learning Models

In various embodiments, a wide variety of machine learning techniques may be used. Examples include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN) and long short-term memory networks (LSTM), may also be used. For example, various implicit context generation performed by software server 110 and other processes may apply one or more machine learning and deep learning techniques.

In various embodiments, the training techniques for a machine learning model may be supervised, semi-supervised, or unsupervised. In supervised learning, the machine learning models may be trained with a set of training samples that are labeled. For example, for a machine learning model trained to determine implicit context, the training samples may be previous user interaction with the dynamic layout software program 120. The labels for each training sample may be binary or multi-class.

By way of example, the training set may include multiple past records with known outcomes. Each training sample in the training set may correspond to a past and the corresponding outcome may serve as the label for the sample. A training sample may be represented as a feature vector that include multiple dimensions. Each dimension may include data of a feature, which may be a quantized value of an attribute that describes the past record. For example, in a machine learning model that is used to determine implicit context, the features in a feature vector may include user intent and a set of parameters for fulfilling the user intent etc. In various embodiments, certain pre-processing techniques may be used to normalize the values in different dimensions of the feature vector.

In some embodiments, an unsupervised learning technique may be used. The training samples used for an unsupervised model may also be represented by features vectors, but may not be labeled. Various unsupervised learning techniques such as clustering may be used in determining similarities among the feature vectors, thereby categorizing the training samples into different clusters. In some cases, the training may be semi-supervised with a training set having a mix of labeled samples and unlabeled samples.

A machine learning model may be associated with an objective function, which generates a metric value that describes the objective goal of the training process. The training process may intend to reduce the error rate of the model in generating predictions. In such a case, the objective function may monitor the error rate of the machine learning model. In a model that generates predictions, the objective function of the machine learning algorithm may be the training error rate when the predictions are compared to the actual labels. Such an objective function may be called a loss function. Other forms of objective functions may also be used, particularly for unsupervised learning models whose error rates are not easily determined due to the lack of labels. In various embodiments, the error rate may be measured as cross-entropy loss, L1 loss (e.g., the sum of absolute differences between the predicted values and the actual value), L2 loss (e.g., the sum of squared distances).

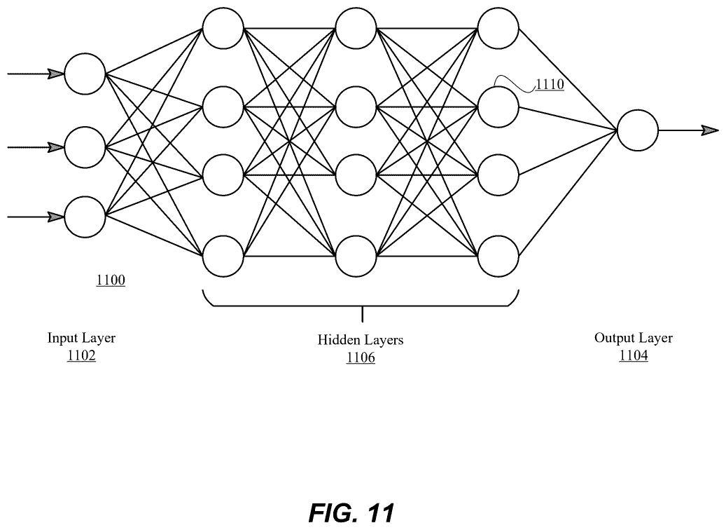

Referring to FIG. 11, a structure of an example neural network is illustrated, in accordance with some embodiments. The neural network 1100 may receive an input and generate an output. The input may be the feature vector of a training sample in the training process and the feature vector of an actual case when the neural network is making an inference. The output may be the prediction, classification, or another determination performed by the neural network. The neural network 1100 may include different kinds of layers, such as convolutional layers, pooling layers, recurrent layers, fully connected layers, and custom layers. A convolutional layer convolves the input of the layer (e.g., an image) with one or more kernels to generate different types of images that are filtered by the kernels to generate feature maps. Each convolution result may be associated with an activation function. A convolutional layer may be followed by a pooling layer that selects the maximum value (max pooling) or average value (average pooling) from the portion of the input covered by the kernel size. The pooling layer reduces the spatial size of the extracted features. In some embodiments, a pair of convolutional layer and pooling layer may be followed by a recurrent layer that includes one or more feedback loops. The feedback may be used to account for spatial relationships of the features in an image or temporal relationships of the objects in the image. The layers may be followed by multiple fully connected layers that have nodes connected to each other. The fully connected layers may be used for classification and object detection. In one embodiment, one or more custom layers may also be presented for the generation of a specific format of the output. For example, a custom layer may be used for image segmentation for labeling pixels of an image input with different segment labels.

The order of layers and the number of layers of the neural network 1100 may vary in different embodiments. In various embodiments, a neural network 1100 includes one or more layers 1102, 1104, and 1106, but may or may not include any pooling layer or recurrent layer. If a pooling layer is present, not all convolutional layers are always followed by a pooling layer. A recurrent layer may also be positioned differently at other locations of the CNN. For each convolutional layer, the sizes of kernels (e.g., 3×3, 5×5, 7×7, etc.) and the numbers of kernels allowed to be learned may be different from other convolutional layers.

A machine learning model may include certain layers, nodes 1110, kernels and/or coefficients. Training of a neural network, such as the neural network 1100, may include forward propagation and backpropagation. Each layer in a neural network may include one or more nodes, which may be fully or partially connected to other nodes in adjacent layers. In forward propagation, the neural network performs the computation in the forward direction based on the outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Training of a machine learning model may include an iterative process that includes iterations of making determinations, monitoring the performance of the machine learning model using the objective function, and backpropagation to adjust the weights (e.g., weights, kernel values, coefficients) in various nodes 1110. The computing device may adjust, in a backpropagation, the weights of the machine learning model based on the comparison. The computing device backpropagates one or more error terms obtained from one or more loss functions to update a set of parameters of the machine learning model. The backpropagating may be performed through the machine learning model and one or more of the error terms based on a difference between a label in the training sample and the generated predicted value by the machine learning model.

By way of example, each of the functions in the neural network may be associated with different coefficients (e.g., weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tanh), and rectified linear unit functions (ReLU). After an input is provided into the neural network and passes through a neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., the machine learning model has converged) or after a predetermined number of rounds for a particular set of training samples. The trained machine learning model can be used for performing identifying and generating implicit context or another suitable task for which the model is trained.

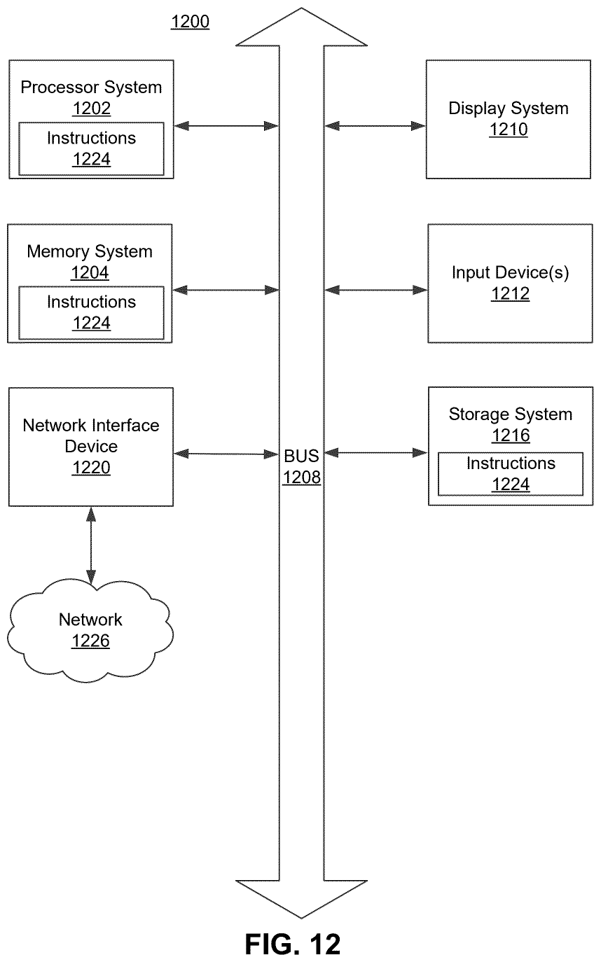

Turning now to FIG. 12, illustrated is an example machine to read and execute computer readable instructions, in accordance with an embodiment. Specifically, FIG. 12 shows a diagrammatic representation of the data processing service 102 (and/or data processing system) in the example form of a computer system 1200. The computer system 1200 is structured and configured to operate through one or more other systems (or subsystems) as described herein. The computer system 1200 can be used to execute instructions 1224 (e.g., program code or software) for causing the machine (or some or all of the components thereof) to perform any one or more of the methodologies (or processes) described herein. In executing the instructions, the computer system 1200 operates in a specific manner as per the functionality described. The computer system 1200 may operate as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The computer system 1200 may be a server computer, a client computer, a personal computer (PC), a tablet PC, a smartphone, an internet of things (IoT) appliance, a network router, switch or bridge, or other machine capable of executing instructions 1224 (sequential or otherwise) that enable actions as set forth by the instructions 1224. Further, while only a single machine is illustrated, the term “machine” shall also be taken to include any collection of machines that individually or jointly execute instructions 1224 to perform any one or more of the methodologies discussed herein.

The example computer system 1200 includes a processing system 1202. The processor system 1202 includes one or more processors. The processor system 1202 may include, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The processor system 1202 executes an operating system for the computing system 1200. The computer system 1200 also includes a memory system 1204. The memory system 1204 may include or more memories (e.g., dynamic random access memory (RAM), static RAM, cache memory). The computer system 1200 may include a storage system 1216 that includes one or more machine readable storage devices (e.g., magnetic disk drive, optical disk drive, solid state memory disk drive).

The storage system 1216 stores instructions 1224 (e.g., software) embodying any one or more of the methodologies or functions described herein. The instructions 1224 may also reside, completely or at least partially, within the memory system 1204 or within the processing system 1202 (e.g., within a processor cache memory) during execution thereof by the computer system 1200, the memory system (one or more memories) 1204 and the processor system 1202 also constituting machine-readable media. The instructions 1224 may be transmitted or received over a network 1226, such as the network 1226, via the network interface system 1220.

The storage system 1216 should be taken to include a single medium or multiple media (e.g., a centralized or distributed database, or associated caches and servers communicatively coupled through the network interface system 1220) able to store the instructions 1224. The term “machine-readable medium” shall also be taken to include any medium that is capable of storing instructions 1224 for execution by the machine and that cause the machine to perform any one or more of the methodologies disclosed herein. The term “machine-readable medium” includes, but not be limited to, data repositories in the form of solid-state memories, optical media, and magnetic media.

In addition, the computer system 1200 can include a display system 1210. The display system 1210 may driver firmware (or code) to enable rendering on one or more visual devices, e.g., drive a plasma display panel (PDP), a liquid crystal display (LCD), or a projector. The computer system 1200 also may include one or more input/output systems 1212. The input/output (IO) systems 1212 may include input devices (e.g., a keyboard, mouse (or trackpad), a pen (or stylus), microphone) or output devices (e.g., a speaker). The computer system 1200 also may include a network interface system 1220. The network interface system 1220 may include one or more network devices that are configured to communicate with an external network 1226. The external network 1226 may be a wired (e.g., ethernet) or wireless (e.g., WiFi, BLUETOOTH, near field communication (NFC).

The processor system 1202, the memory system 1204, the storage system 1216, the display system 1210, the IO systems 1212, and the network interface system 1220 are communicatively coupled via a computing bus 1208.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Embodiments according to the invention are in particular disclosed in the attached claims directed to a method and a computer program product, wherein any feature mentioned in one claim category, e.g. method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject-matter which can be claimed comprises not only the combinations of features as set out in the disclosed embodiments but also any other combination of features from different embodiments. Various features mentioned in the different embodiments can be combined with explicit mentioning of such combination or arrangement in an example embodiment. Furthermore, any of the embodiments and features described or depicted herein can be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In one embodiment, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed by the specific order claimed or described in the disclosure. Some steps may be performed before others even though the other steps are claimed or described first in this disclosure.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

1. A computer-implemented method, comprising:
displaying a first set of generative interfaces in a user interface, each generative interface comprising one or more user interface elements, each user interface element containing content specifying information of the generative interface;
monitoring user inputs to the user interface, the user inputs including at least a user interaction from a user with one of the one or more user interface elements;
responsive to receiving the user interaction with a user interface element in a generative interface, activating a dynamic input phase of the user interface, the dynamic input phase dynamically generating responses during runtime of receiving user inputs to the user interface;
updating the user interface by accentuating the user interface element that is interacted by the user;
receiving a second user input during the dynamic input phase;
identifying, using a natural language analysis, content from the second user input;
applying a machine learning model to the generative interface comprising the interacted user interface element, the content contained in the interacted user interface element and the content from the second user input;
receiving an output from the machine learning model content in response to the user interaction and the second user input; and
updating the user interface to display a second set of generative interfaces comprising one or more runtime-determined user interface elements, each runtime-determined user interface element comprising information associated with the received content.

2. The method of claim 1, wherein each generative interface comprises one or more girds, and each user interface element corresponds to a grid that is interactable by a tactile input from the user.

3. The method of claim 2, wherein updating the user interface by accentuating the user interface that is interacted by the user comprises:
identifying at least one grid of the interacted generative interface corresponding to the tactile input; and
updating the user interface by accentuating the at least one grid interacted by the tactile input.

4. The method of claim 3, wherein the content in response to the user interaction and the second user input corresponds to an additional grid of the interacted generative interface, and at least one of the runtime-determined user interface elements corresponds to the additional grid.

5. The method of claim 2, wherein receiving an output from the machine learning model content in response to the user interaction and the second user input comprises:
identifying at least one grid of the interacted generative interface corresponding to the tactile input; and
updating the user interface by accentuating the at least one grid interacted by the tactile input.

6. The method of claim 1, wherein monitoring user inputs to the user interface comprises:
receiving, via a tactile input sensor, a tactile input from the user interacting with one of the set of generative interfaces.

7. The method of claim 1, wherein the second user input comprises a user voice input.

8. A non-transitory computer readable storage medium comprising stored program code, the program code comprising instructions, the instructions when executed cause a processor system to:
display a first set of generative interfaces in a user interface, each generative interface comprising one or more user interface elements, each user interface element containing content specifying information of the generative interface;
monitor user inputs to the user interface, the user inputs including at least a user interaction from a user with one of the one or more user interface elements;
responsive to receiving the user interaction with a user interface element in a generative interface, activate a dynamic input phase of the user interface, the dynamic input phase dynamically generating responses during runtime of receiving user inputs to the user interface;
update the user interface by accentuating the user interface element that is interacted by the user;
receive a second user input during the dynamic input phase;
identify, using a natural language analysis, content from the second user input;
apply a machine learning model to the generative interface comprising the interacted user interface element, the content contained in the interacted user interface element and the content from the second user input;
receive an output from the machine learning model content in response to the user interaction and the second user input; and
update the user interface to display a second set of generative interfaces comprising one or more runtime-determined user interface elements, each runtime-determined user interface element comprising information associated with the received content.

9. The non-transitory computer readable storage medium of claim 8, wherein each generative interface comprises one or more girds, and each user interface element corresponds to a grid that is interactable by a tactile input from the user.

10. The non-transitory computer readable storage medium of claim 9, wherein the instructions to update the user interface by accentuating the user interface that is interacted by the user, when executed further cause the processor system to:
identify at least one grid of the interacted generative interface corresponding to the tactile input; and
update the user interface by accentuating the at least one grid interacted by the tactile input.

11. The non-transitory computer readable storage medium of claim 10, wherein the content in response to the user interaction and the second user input corresponds to an additional grid of the interacted generative interface, and at least one of the runtime-determined user interface elements corresponds to the additional grid.

12. The non-transitory computer readable storage medium of claim 9, wherein the instructions to receive an output from the machine learning model content in response to the user interaction and the second user input, when executed further cause the processor system to:
identify at least one grid of the interacted generative interface corresponding to the tactile input; and
update the user interface by accentuating the at least one grid interacted by the tactile input.

13. The non-transitory computer readable storage medium of claim 8, the instructions to monitor user inputs to the user interface, when executed further cause the processor system to:
receive, via a tactile input sensor, a tactile input from the user interacting with one of the set of generative interfaces.

14. The non-transitory computer readable storage medium of claim 8, wherein the second user input comprises a user voice input.

15. A system comprising:
one or more computer processors; and
one or more computer-readable mediums comprising stored instructions that, when executed by the one or more computer processors, cause the system to:
display a first set of generative interfaces in a user interface, each generative interface comprising one or more user interface elements, each user interface element containing content specifying information of the generative interface;
monitor user inputs to the user interface, the user inputs including at least a user interaction from a user with one of the one or more user interface elements;
responsive to receiving the user interaction with a user interface element in a generative interface, activate a dynamic input phase of the user interface, the dynamic input phase dynamically generating responses during runtime of receiving user inputs to the user interface;
update the user interface by accentuating the user interface element that is interacted by the user;
receive a second user input during the dynamic input phase;
identify, using a natural language analysis, content from the second user input;
apply a machine learning model to the generative interface comprising the interacted user interface element, the content contained in the interacted user interface element and the content from the second user input;
receive an output from the machine learning model content in response to the user interaction and the second user input; and
update the user interface to display a second set of generative interfaces comprising one or more runtime-determined user interface elements, each runtime-determined user interface element comprising information associated with the received content.

16. The system of claim 15, wherein each generative interface comprises one or more girds, and each user interface element corresponds to a grid that is interactable by a tactile input from the user.

17. The system of claim 16, wherein the instructions to update the user interface by accentuating the user interface that is interacted by the user, when executed further cause the system to:
identify at least one grid of the interacted generative interface corresponding to the tactile input; and
update the user interface by accentuating the at least one grid interacted by the tactile input.

18. The system of claim 17, wherein the content in response to the user interaction and the second user input corresponds to an additional grid of the interacted generative interface, and at least one of the runtime-determined user interface elements corresponds to the additional grid.

19. The system of claim 16, wherein the instructions to receive an output from the machine learning model content in response to the user interaction and the second user input, when executed further cause the system to:
identify at least one grid of the interacted generative interface corresponding to the tactile input; and
update the user interface by accentuating the at least one grid interacted by the tactile input.

20. The system of claim 15, the instructions to monitor user inputs to the user interface, when executed further cause the system to:
receive, via a tactile input sensor, a tactile input from the user interacting with one of the set of generative interfaces.
